(19) United States
(12) Patent Application Publication
(10) Pub. No.: US 2025/0280089 A1
(43) Pub. Date: Sep. 4, 2025

(54) INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: YUKI KANAGAWA, Chiba (JP)

(21) Appl. No.: 19/062,261

(22) Filed: Feb. 25, 2025

(30) Foreign Application Priority Data
Mar. 4, 2024 (JP) 2024-031977

(51) Int. Cl. H04N 1/203; H04N 1/00

(52) U.S. Cl. CPC H04N 1/2038; H04N 1/00413; H04N 1/00482; H04N 1/00639; H04N 1/00816

(57) ABSTRACT

An information processing apparatus comprising at least one memory and at least one processor which function as a consolidation unit that configures a setting for consolidating a plurality of sets of image data on a single sheet and a determination unit that automatically determines a position to perforate the sheet based on the setting configured by the consolidation unit.

### BACKGROUND

### Field

The present disclosure relates to an information processing apparatus, a method for controlling the information processing apparatus, and a storage medium.

### Description of the Related Art

Conventionally, some generally used sheets can be perforated to be tearable. Some multifunctional devices are known to have the function of setting perforation positions on a sheet and perforating the sheet in execution of copy or print.

Japanese Patent Laid-Open No. 2019-81318 discloses a technique of displaying perforation lines on a preview of a scanned original and allowing the positions of the perforation lines to be adjusted.

### SUMMARY

What is in demand is a technique for allowing a user to configure sheet processing settings more easily on a setting screen.

An information processing apparatus according to an aspect of the present disclosure has a consolidation unit that configures a setting for consolidating a plurality of sets of image data on a single print sheet and a determination unit that automatically determines a position to perforate the sheet based on the setting configured by the consolidation unit.

Further features of the present invention will become apparent from the following description of exemplary embodiments with reference to the attached drawings.

### BRIEF DESCRIPTION OF THE DRAWINGS

FIG. 1 is a system configuration diagram;

FIG. 2 is a hardware configuration diagram of an image processing apparatus;

FIG. 3 is a software configuration diagram of the image processing apparatus;

FIG. 4 is a diagram showing a screen showing a list of setting items for copy or print;

FIG. 5 is a diagram showing a page consolidation setting screen;

FIG. 6 is a flowchart of perforation setting;

FIG. 7 is a flowchart of automatic perforation position determination;

FIG. 8 is a flowchart of automatic perforation position determination;

FIG. 9 is a diagram showing an image repeat setting screen;

FIG. 10 is a flowchart of automatic perforation position determination;

FIG. 11 is a diagram showing a setting screen for manually specifying perforation positions;

FIG. 12 is a diagram showing a screen displaying a list of specified perforation positions;

FIG. 13 is a flowchart of control performed in a case where an earlier operation is prioritized;

FIG. 14 is a flowchart of control performed in a case where an earlier operation is prioritized;

FIG. 15 is a flowchart of control performed in a case where a later operation is prioritized;

FIG. 16 is a flowchart of control performed in a case where a later operation is prioritized;

FIG. 17 is a diagram showing a setting screen for switching a setting regarding specification of perforation positions;

FIG. 18 is a diagram showing a software configuration diagram of an information processing apparatus;

FIG. 19 is a diagram showing a printer driver's setting screen; and

FIGS. 20A and 20B are diagrams illustrating a concrete example of an image consolidation function.

### DESCRIPTION OF THE EMBODIMENTS

The present disclosure is described in detail below with reference to the drawings. Note that embodiments below are not to limit the present disclosure according to the scope of claims, and not all the combinations of the features described in the embodiments are necessarily essential as solutions provided by the present disclosure. Also, throughout the drawings attached hereto, the same or like configurations are denoted by the same reference number to omit repetitive descriptions.

### Embodiment 1

### <System Configuration>

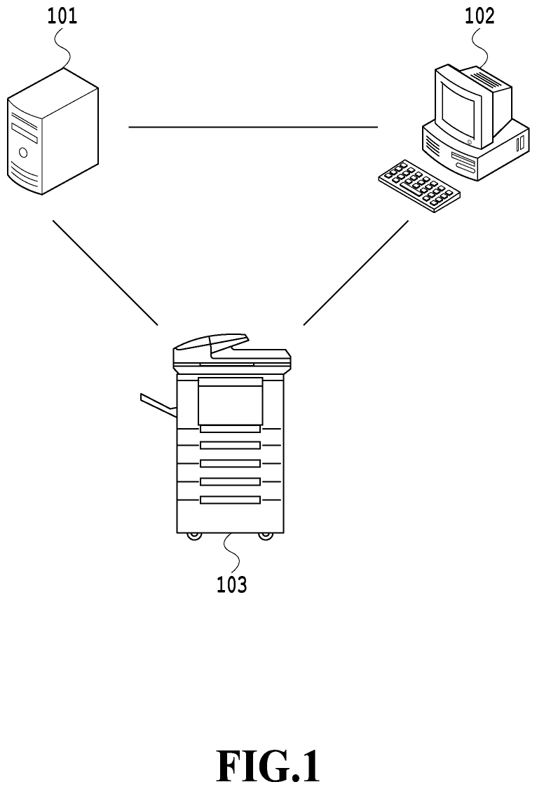

FIG. 1 is a schematic diagram showing the configuration of a printing and processing system having an image processing apparatus according to the present embodiment. The printing and processing system of the present embodiment is a system formed by an image processing apparatus 103, a server personal computer (PC) 101 being an information processing apparatus, and a client PC 102 being an information processing apparatus, which are connected via a network.

The image processing apparatus 103 is a multifunction peripheral (MFP). The image processing apparatus 103 has the function of copying a paper original and the function of printing print data sent from an external printer driver. The image processing apparatus 103 also has the function of scanning a paper original and sending scanned image data to an external file server (the server PC 101) or to an email address (the Send function or the Scan-to-Send function). The image processing apparatus 103 also has the function of transmitting data to another image processing apparatus to have the data printed by the destination image processing apparatus (the Remote Copy function or the Fax function). The image processing apparatus 103 may have other various functions. Note that the functions described above are merely examples, and the functions of the image processing apparatus 103 are not limited to them. The image processing apparatus 103 may be an apparatus having a single function. The image processing apparatus 103 used in the present embodiment may employ the electrophotographic printing method, the inkjet printing method, or other printing methods.

The server PC 101 or the client PC 102 can configure settings related to printing or processing using a printer driver and instruct the image processing apparatus 103 to print or process via a network set.

The image processing apparatus 103 is connected to the server PC 101 and the client PC 102 by, for example, Ethernet (registered trademark) herein, but the present disclosure is not limited to this example.

Also, although a plurality of apparatuses are described as an example, the server PC 101 and the client PC 102, for example, may be formed by the same computer. It is also possible to incorporate the server PC 101 and the client PC 102 into the image processing apparatus 103 so that the system 100 is formed by the image processing apparatus 103 alone. Although the image processing apparatus 103 is shown as an example of the information processing apparatus in the present embodiment, it is to be noted that the information processing apparatus is not limited to the image processing apparatus 103 and may be a PC, a terminal apparatus, or a smartphone.

### <Hardware Configuration of the Image Processing Apparatus>

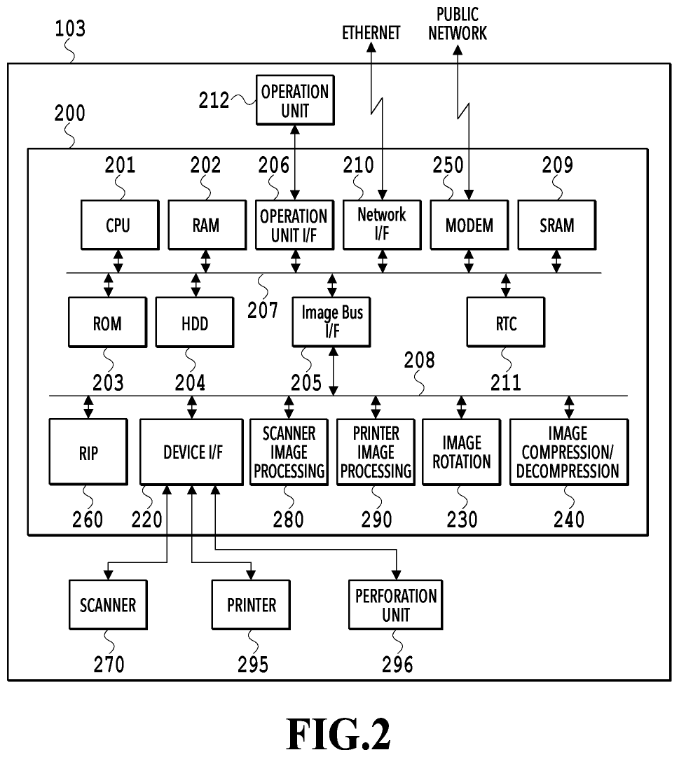

FIG. 2 is a block diagram showing a hardware configuration of the image processing apparatus 103 according to the present embodiment. A controller unit 200 is connected to a scanner 270, which is an image input device, or a printer 295, which is an image output device. Meanwhile, the controller unit 200 is connected to Ethernet (registered trademark) or a public network to receive and output image information and device information.

A CPU 201 is a controller that controls the image processing apparatus 103. A RAM 202 is system work memory used for the CPU 201 to operate and is also image memory to temporarily store image data. A ROM 203 is a boot ROM to store a boot program for the system. An HDD 204 is a hard disk drive where system software, applications, and image data are stored.

An operation unit I/F 206 is an interface with an operation unit 212 having a touch panel and outputs image data to be displayed on the operation unit 212 to the operation unit 212. The operation unit I/F 206 also serves the role of conveying information entered on the operation unit 212 by a system user to the CPU 201. A network I/F 210 is connected to the network and enables input and output of information. A modem 250 is connected to the public network and enables input and output of information.

An SRAM 209 is a non-volatile storage medium capable of high speed operation. An RTC 211 is a real-time clock and keeps counting the current time even with no power being supplied to the controller unit 200. The aforementioned devices are disposed on a system bus 207.

An image bus I/F 205 is a bus bridge connecting the system bus 207 and an image bus 208, which transfers image data at high speed, to convert data structures. The image bus 208 is configured by a PCI bus or IEEE 1394. The following devices are disposed on the image bus 208.

A RIP 260 is a raster image processor and converts PDL code into an bitmap image. A device I/F unit 220 is connected to the scanner 270 and the printer 295, which are image input and output devices, and to the controller unit 200 and performs conversion of image data between synchronous and asynchronous systems. A scanner image processing unit 280 corrects, processes, and edits input image data. A printer image processing unit 290 performs printer corrections, resolution conversion, and the like on print output image data. An image rotation unit 230 rotates image data. An image compression/decompression unit 240 performs compression processing and decompression processing.

A perforation unit 296 is connected to the controller unit 200 via the device I/F unit 220 and processes a sheet outputted from the printer image processing unit 290 by making dotted lines of perforation in the sheet. Although the image processing apparatus 103 of the present embodiment includes the perforation unit 296 so that a sheet can be perforated in the image processing apparatus 103, it is to be noted that printing and processing may be executed by different apparatuses. In this case, for example, a sheet printed by the image processing apparatus 103 is conveyed to another apparatus where the sheet is perforated.

### <Software Configuration of the Image Processing Apparatus>

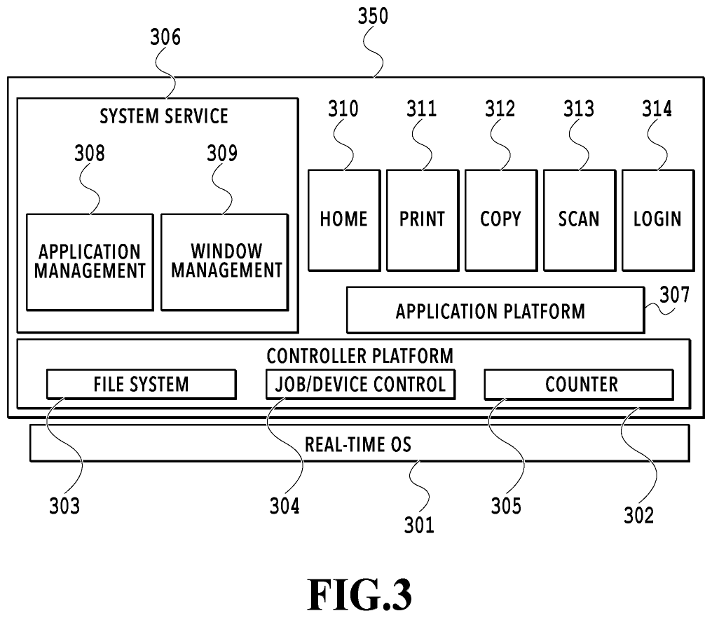

FIG. 3 is a block diagram showing a software configuration of the image processing apparatus 103 according to the invention of the present application. This software is stored in the HDD 204 of the image processing apparatus 103 as firmware 350 and is loaded into the RAM 202 and executed by the CPU 201.

A real-time OS 301 is a real-time operating system and provides software running thereon with a service and its framework for management of various resources optimized for control of an embedded system. The service and framework for management of various resources provided by the real-time OS includes: multitask (thread) management that substantially enables a plurality of processes to operate in tandem by managing a plurality of processing execution contexts by the CPU; inter-task communications that enables synchronization or data exchange between tasks; and a protocol stack implementing memory management, interrupt management, various device drivers, or various protocols' processing (such as a local interface, a network, or communication).

A controller platform 302 is formed of a file system 303, a job/device control 304, a counter 305, and the like. The file system 303 is a mechanism for storing data built on a storage device such as the HDD 204 or the RAM 202. The job/device control 304 controls the hardware of the image processing apparatus 103 and also controls jobs that use the basic functions (such as print, scan, communication, and image conversion) provided mainly by the hardware of the image processing apparatus 103. The counter 305 manages counter values related to expiry of each application, printing, or scanning, which are stored in the SRAM 209.

A system service 306 is formed by application management 308, window management 309, and the like. The application management 308 is a management module for installing, uninstalling, starting, or stopping, e.g., applications 310 to 314. The applications are, for example, home 310, print 311, copy 312, scan 313, and login 314. The window management 309 is a management module for controlling the order of displaying application windows of the applications.

An application platform 307 is middleware for allowing the real-time OS 301 and the mechanisms of the controller platform 302 to be used from each application.

The applications are applied software implementing various business models by using functions provided by the application platform 307. The home 310 includes a menu function for selecting an application. The print 311 is a print function for printing a received print job of digital data on a sheet. The copy 312 is a copy function for making a copy of a paper original. The scan 313 is a scan function for sending data. Upon receipt of a login notification, each application performs screen generation processing appropriate for the logged-in user based on information on the notification. For example, in an example where a logged-in user is prohibited from using the web browser or from making a color copy, the home 310 performs processing so that the logged-in user cannot select the web browser that they are not allowed to use or performs processing so that the logged-in user cannot select a button for color copy.

The login 314 is authentication software for performing user authentication. The login 314 performs login processing based on a username and a password entered on the operation unit 212. In a case where the authentication fails, an error message is displayed, and in a case where the authentication succeeds, a series of steps to be performed after authentication is performed.

The image processing apparatus 103 has an image consolidation function for printing a plurality of images on a single sheet. This image consolidation function includes, for example, what is called the page consolidation function or the N-up function, where N originals are allocated and printed onto a single sheet. The image consolidation function also includes what is called an image repeat function, where a plurality of images are allocated and printed onto a single sheet according to settings to print a particular image X times vertically and Y times horizontally. Note that X and Y above are natural numbers, and thus, the image repeat function of the present embodiment may be configured to print the same image repeatedly only vertically or horizontally. These image consolidation functions may be used for usage where, for example, images on a sheet may be torn off piece by piece and distributed, such as coupons. Thus, in a case where the image consolidation function is set, it is convenient for a user to be able to select, on the same setting screen, the perforation setting for perforating the sheet for every image, and this may offer improved efficiency in configuring settings.

The exiting methods require the image consolidation function and the perforation setting to be set on different screens, and improvement in efficiency is called for from the perspective of efficiency in configuring settings. Also, in an existing known perforation setting method, the position to draw a perforation line on a sheet is specified manually with a numerical value. Also, to specify a plurality of perforation lines, the above operation needs to be repeated for each perforation line, which is problematic in terms of efficiency in configuring settings. Also, in order to accurately specify the position of a perforation line manually with a numerical value, it is necessary to measure the sheet with a measuring device such as a scale and check the position to draw a perforation line in advance before printing, which is troublesome.

The present embodiment described below proposes a method where for each image, the setting of the image consolidation function and the setting of sheet perforation can be set on the same setting screen. In the present embodiment, perforation positions are automatically determined based on the image consolidation function. Thus, even in a case where there are a plurality of perforation lines to specify, less trouble is involved in configuring settings. Specifically, the present embodiment eliminates the trouble of measuring a sheet with a scale or the like beforehand and determining perforation positions accurately.

### <Screens Displayed According to Embodiment 1>

Next, a control method of Embodiment 1 is described.

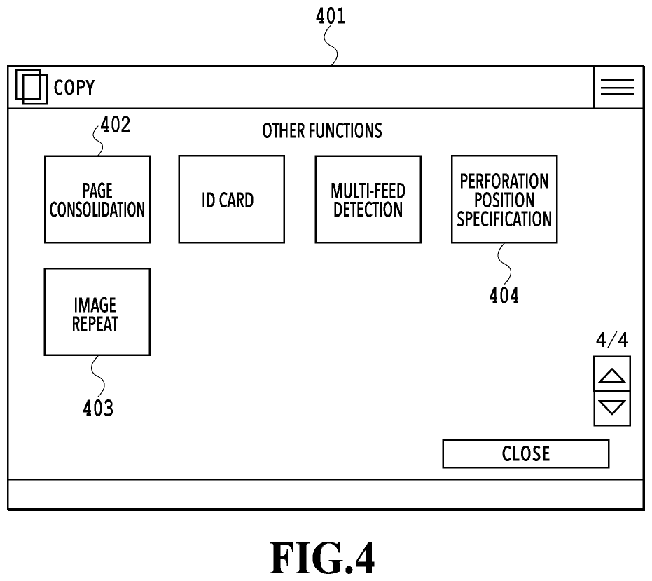

FIG. 4 is a diagram showing a screen with a list of setting items of the present embodiment. A list screen 401 shown in FIG. 4 shows some of the functions which may optionally be set by a user for execution of the copy 312. Note that the list screen 401 shown in FIG. 4 can be applied to the print 311 as well. The setting items list screen 401 of the present embodiment is outputted from the window management 309 to the operation unit 212. The window management 309 is stored as the firmware 350 in the HDD 204 of the image processing apparatus 103 and is loaded into the RAM 202 and executed by the CPU 201. The setting items list screen 401 has setting items to be configured for copy or print, such as, for example, page consolidation 402, image repeat 403, and perforation position specification 404.

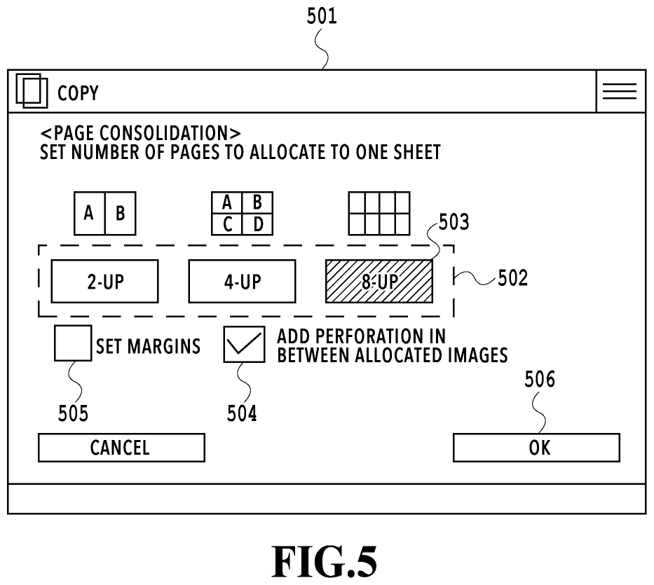

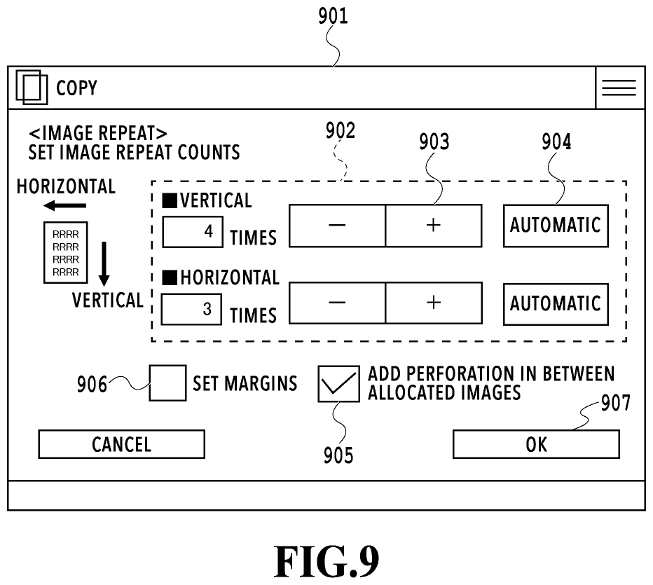

For example, upon detection of selection of the page consolidation 402, the CPU 201 performs display control to display a page consolidation function setting screen 501 shown in FIG. 5 on the operation unit 212. Also, upon detection of selection of, for example, the image repeat 403, the CPU 201 displays an image repeat function setting screen 901 shown in FIG. 9 to be described later.

FIG. 5 is a diagram showing a setting screen for the image consolidation function. Specifically, FIG. 5 shows the page consolidation function setting screen 501 for setting the function of allocating and printing a plurality of originals onto a single sheet, which is called N-up. The page consolidation function setting screen 501 of the present embodiment is outputted from the window management 309 to the operation unit 212.

The window management 309 is stored as the firmware 350 in the HDD 204 of the image processing apparatus 103 and is loaded into the RAM 202 and executed by the CPU 201. The page consolidation function setting screen 501 has setting items to be set for execution of the print 311 or the copy 312, and N (N is specified as a multiple of 2) images are allocated and printed on a single sheet based on the settings configured. The page consolidation function setting screen 501 has N-up set values 502 for setting how many images to allocate to a single sheet.

For example, an 8-up setting value 503 is one of the N-up set values 502, and in a case where the 8-up setting value 503 is set, eight original images are printed on a single sheet. The page consolidation function setting screen 501 has, separately from the N-up set values 502 for page consolidation, a checkbox 504 for automatically setting perforation positions, which is used to set perforation lines for the sheet so that each image allocated to the sheet can be torn off. In a case where any of the N-up set values 502 is enabled, the checkbox 504 for automatically setting perforation positions can be used to enable or disable (i.e., switch) the setting for perforating the sheet in between the allocated pages. A checkbox 505 for setting margins is an entry field which, by being enabled, can add margins of preset lengths to a print sheet. Once an OK button 506 disposed on the page consolidation function setting screen 501 is pressed, set values, such as the N-up set value 502 and the checkbox 504 for automatically setting perforation positions, are recorded in the RAM 202 or the HDD 204.

### <Flowcharts According to Embodiment 1>

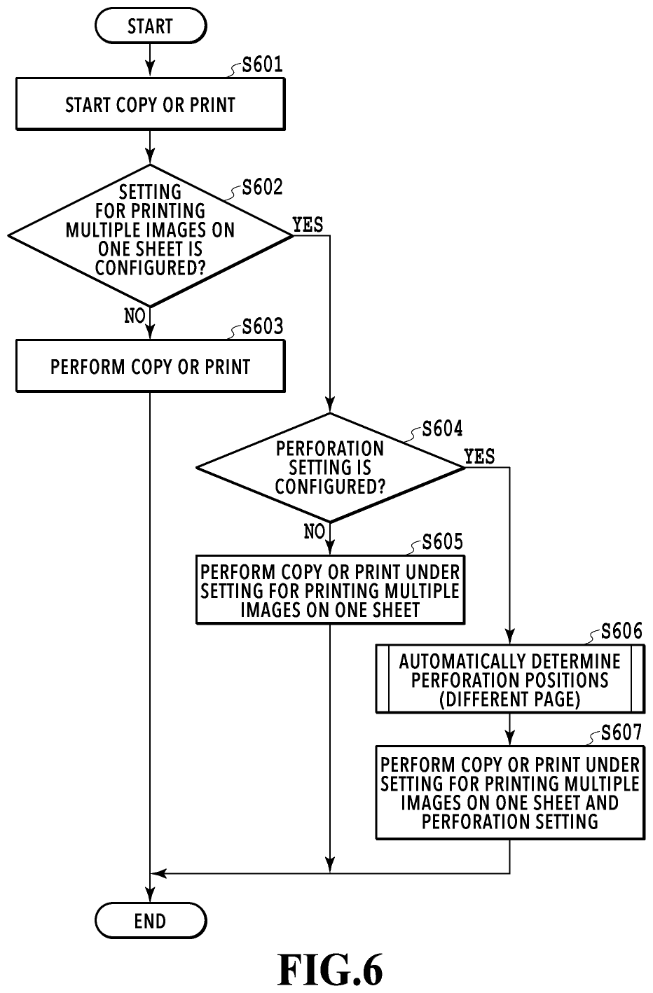

FIG. 6 is a flowchart for performing copy or print according to the present embodiment. Specifically, in the flowchart, it is determined whether the perforation setting is set in addition to the image consolidation function setting for printing N images on a single sheet, and processing is executed in accordance with the determination. The firmware 350 according to the processing of the present embodiment is stored in the HDD 204 of the image processing apparatus 103 and is loaded into the RAM 202 and executed by the CPU 201. The present processing starts upon detection of an operation for staring copy or print. Also, the letter “S” in the description of each process in the flowchart means that it is a step in the flowchart, and this applies to the rest of the flowcharts herein.

Although using the page consolidation function is used as one of the image consolidation functions in the example described in the present flowchart, it is to be noted that the flowchart can in fact be applied to processing for using image repeat, which will be described in a later embodiment.

In S601, the CPU 201 starts copy or print in response to detection of copy or print execution processing. In S602, the CPU 201 determines whether the image consolidation function of printing a plurality of images on a single sheet is set. Specifically, the CPU 201 determines whether either the page consolidation 402 or the image repeat 403 is selected and set on the list screen 401 shown in FIG. 4. If it is determined that the image consolidation function is not set, the CPU 201 proceeds to S603 to execute copy or print. After that, the CPU 201 ends the processing of the present flowchart. By contrast, if it is determined that the image consolidation function is set, the CPU 201 proceeds to S604 to determine whether the perforation setting is set on the setting screen for the image consolidation function selected. If it is determined that the perforation setting is not set, the CPU 201 proceeds to S605 to perform copy or print with the image consolidation function being applied. By contrast, if it is determined that the perforation setting is set, the CPU 201 proceeds to S606.

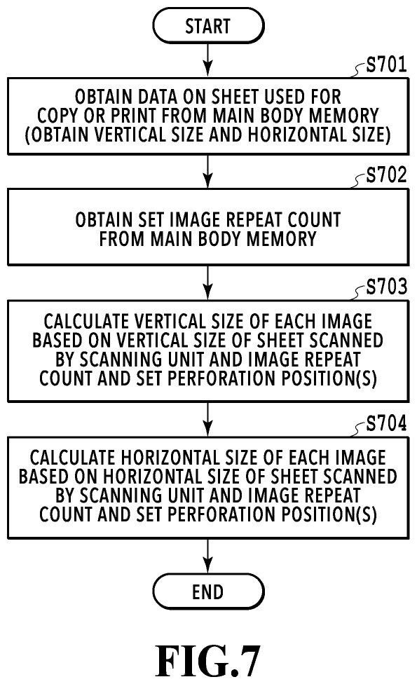

In S606, the CPU 201 determines perforation positions. Details of the perforation position determination in S606 will be described later using FIG. 7. In S607, the CPU 201 performs copy or print according to the settings of the image consolidation function and the perforation setting determined in S602 and S606. After that, the CPU 201 ends the processing of the present flowchart.

FIG. 7 is a flowchart of the perforation position determination according to the present embodiment, or specifically, a flowchart showing details of S606 in FIG. 6 described above. The firmware 350 according to the processing of the present embodiment is stored in the HDD 204 of the image processing apparatus 103 and is loaded into the RAM 202 and executed by the CPU 201.

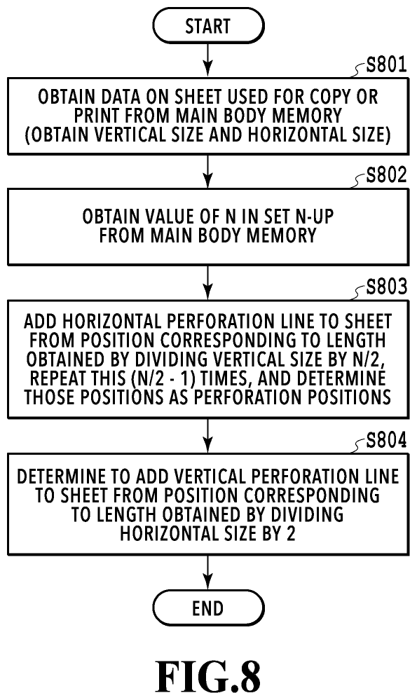

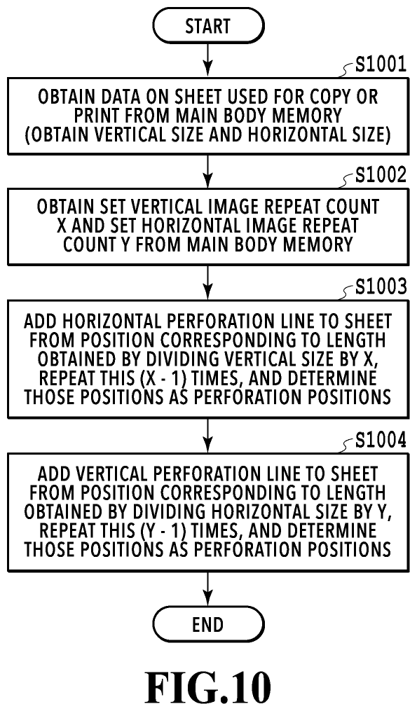

Note that the present processing is a broad concept for both of processing for the page consolidation function, which has been described thus far in the present embodiment, and processing for image repeat, which will be described in a later embodiment. In the present embodiment, first, FIG. 7 is used to describe an overview of processing for adding perforation, and next, FIG. 8 is used to describe a flowchart of processing performed in a case where the processing in FIG. 7 is applied to the page consolidation function (the N-up function). Also, a flowchart of processing performed in a case where the processing in FIG. 7 is applied to the image repeat function will be described later using FIG. 10.

In S701, the CPU 201 obtains the vertical and horizontal sizes of a sheet used for print from the RAM 202. The present processing is also called sheet size obtainment processing.

In S702, the CPU 201 obtains an image repeat count set for the image consolidation function from the RAM 202. The present processing is also called repeat count obtainment processing.

In S703, the CPU 201 determines the position of each horizontal perforation line based on the vertical size of the sheet obtained in the sheet size obtainment processing in S701 and the image repeat count obtained in the repeat count obtainment processing in S702. The present processing is also called horizontal perforation setting processing.

In S704, the CPU 201 determines the position of each vertical perforation line based on the horizontal size of the sheet obtained in the sheet size obtainment processing in S701 and the image repeat count obtained in the repeat count obtainment processing in S702. The present processing is also called vertical perforation setting processing. After that, the CPU 201 ends the processing of the present flowchart. Note that the sheet size obtainment processing in S701 and the repeat count obtainment processing in S702 may be reversed in order. Also, the horizontal perforation setting processing in S703 and the vertical perforation setting processing in S704 may be reversed in order.

FIG. 8 is a flowchart of perforation position determination according to the present embodiment, or specifically, a flowchart showing details of S606 in FIG. 6 described earlier. Also, FIG. 8 is a flowchart performed in a case where the perforation position determination processing described using FIG. 7 is applied to the N-up function. The firmware 350 according to the processing of the embodiment is stored in the HDD 204 of the image processing apparatus 103 and is loaded into the RAM 202 and executed by the CPU 201.

In S801, the CPU 201 obtains the vertical and horizontal sizes of a sheet used for print from the RAM 202.

In S802, the CPU 201 obtains a division number (the value of N in N-up) from the RAM 202. Note that N is a multiple of 2.

In S803, the CPU 201 sets a horizontal perforation line to the sheet from a position corresponding to a length obtained by dividing the vertical size of the sheet obtained in S801 by N/2 using the value of N obtained in S802, and repeats this (N/2−1) times. Then, the CPU 201 determines those positions as the positions of horizontal perforation lines. Note that in a case where margins are set for the sheet to be printed, the CPU 201 may set a horizontal perforation line to the sheet from a position corresponding to a length obtained by dividing the vertical size of the sheet minus the margins by N/2, repeat this (N/2−1) times, and determine those positions as the positions of horizontal perforation lines.

In S804, the CPU 201 determines the position of a vertical perforation line by setting a vertical perforation line to the sheet at a position corresponding to a length obtained by dividing the horizontal size of the sheet obtained in S801 by 2. After that, the CPU 201 ends the processing of the present flowchart. Note that in a case where margins are set for the sheet to be printed, the CPU 201 may determine the position of a vertical perforation line by setting a vertical perforation line to the sheet from a position corresponding to a length obtained by dividing the horizontal size of the sheet minus the margins by 2.

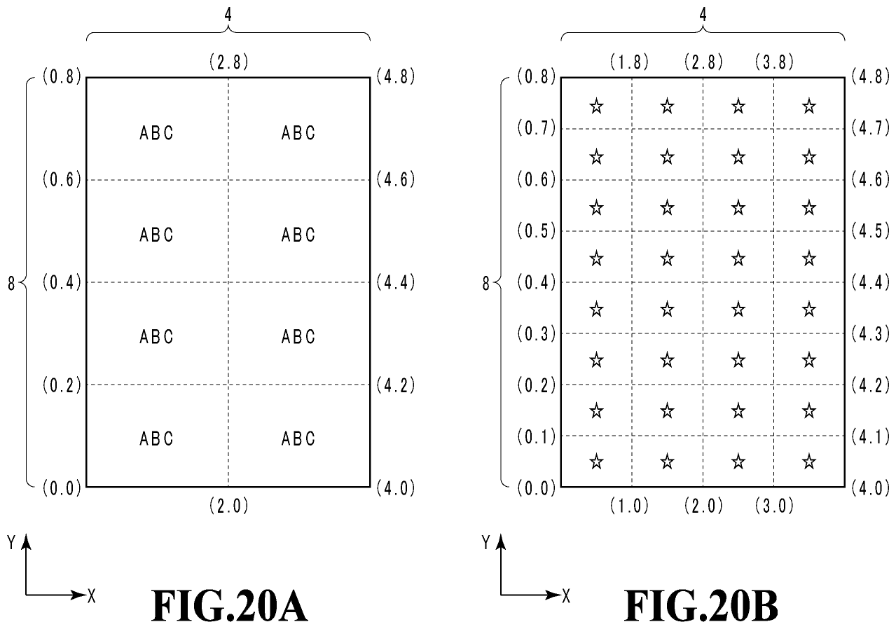

FIGS. 20A and 20B are diagrams illustrating concrete examples of the image consolidation function. A concrete example of the flowchart of the N-up perforation position determination described above is described with reference to FIG. 20A.

It is assumed here that the sheet size obtained by the CPU 201 in S801 is “8” as the vertical size and “4” as the horizontal size. It is also assumed here that the division number N obtained by the CPU 201 in S802 is “8.” This setting means that eight originals are allocated to a sheet with a size of 8×4.

In S803, the CPU 201 determines the positions of horizontal perforation lines. Specifically, the CPU 201 sets a horizontal (X-direction) perforation line from the position of “2,” which is a length obtained by dividing the vertical sheet size “8” by “8/2.” The CPU 201 repeats this (8/2−1) times (i.e., three times). With the coordinates of the lower left corner of the sheet being (0, 0), perforation lines are set from the positions (0, 2), (0, 4), and (0, 6) to the positions (4, 2), (4, 4), and (4, 6), respectively.

In S804, the CPU 201 determines the position of a vertical perforation line. Specifically, the CPU 201 sets a vertical (Y-direction) perforation line from a position (2, 0) corresponding to a length obtained by dividing the horizontal sheet size “4” by “2.” With the coordinates of the lower left corner of the sheet being (0, 0), a perforation line is set from the position (2, 0) to the position (2, 8).

As thus described, for 8-up, a single vertical perforation line and three horizontal perforation lines are drawn, and the sheet is divided into eight equal parts by the perforation lines.

As an alternative way, values of perforation positions determined beforehand for various sheet sizes and various N-up settings may be stored in the HDD 204 or the RAM 202 in a table format to replace S606. For instance, in a case where 4-up is set for an A4 standard-size sheet measuring 297 mm vertically and 210 mm horizontally, values stored in a table may indicate that a vertical perforation line is drawn at the position 148.5 mm and a horizontal perforation line is drawn at the position 105 mm. The processing in S607 may be executed in reference to the values of the perforation positions in the table stored in the HDD 204 or the RAM 202.

As thus described, the preset embodiment can improve user convenience regarding their experience on the setting screen. Specifically, the user can set the perforation setting on the setting screen for the image consolidation function. In a case where a user sets the perforation setting, the positions of perforation lines are automatically calculated based on the sheet size and the N-up division setting. This is easier and more convenient and also more efficient than a conventional method where perforation positions are manually specified with numerical values. Also, compared to the method where perforation positions are manually specified with numerical values, the present embodiment saves the trouble of measuring the size of a sheet beforehand with a scale or the like and the trouble of entering accurate numerical values according to those measurement values.

### Embodiment 2

Embodiment 2 has the same basic configuration as Embodiment 1.

### <Screen Displayed According to Embodiment 2>

FIG. 9 is a diagram showing an image consolidation function setting screen according to the present embodiment. Specifically, FIG. 9 shows the image repeat function setting screen 901 for setting what is called the image repeat function, where a single image is printed repeatedly X times vertically and Y times horizontally on a single sheet. The image repeat function setting screen 901 of the present embodiment is outputted from the window management 309 to the operation unit 212. The window management 309 is stored as the firmware 350 in the HDD 204 of the image processing apparatus 103 and is loaded into the RAM 202 and executed by the CPU 201.

The image repeat function setting screen 901 has setting items to be set in execution of the print 311 or the copy 312, and a particular image is printed on a single sheet repeatedly X times vertically and Y times horizontally based on the settings configured. The image repeat function setting screen 901 has image repeat count set values 902 for setting how many times to allocate (repeat) the same image on a single sheet vertically and horizontally. For example, a vertical image set value 903 is one of the set values 902, and the same image is printed on a single sheet repeatedly X times vertically based on the numerical value X specified in the vertical image set value 903 using increase and decrease buttons. Also, in a case where a vertical automatic setting 904 is set, the value specified in the vertical image set value 903 is ignored, and the maximum number of images repeatable on a sheet is automatically calculated.

The image repeat function setting screen 901 has, separately from the image repeat set values 902, a checkbox 905 for automatically setting perforation positions, which is an entry field for setting perforation lines along which a sheet can be torn to separate the images allocated to the sheet one by one. In a case where the image repeat set values 902 are enabled, the checkbox 905 for automatically setting perforation positions can enable or disable (i.e., switch) the setting for perforating the sheet in between allocated images. A checkbox 906 for setting margins is an entry field which, by being enabled, can set margins of preset lengths to a print sheet. Once an OK button 907 disposed on the image repeat function setting screen 901 is pressed, set values such as the image repeat count set values 902 and the checkbox 905 for automatically setting perforation positions are recorded in the RAM 202 or the HDD 204.

### <Flowchart According to Embodiment 2>

FIG. 10 is a flowchart of perforation position determination according to the present embodiment, or specifically, a flowchart showing the details of S606 in FIG. 6 described earlier. The flowchart corresponds to the perforation position determination processing described using FIG. 7 and is executed in a case where it is determined that the perforation setting is set in addition to the image repeat function as one of image consolidation functions of printing N images on a single sheet. The firmware 350 according to the processing of the embodiment is stored in the HDD 204 of the image processing apparatus 103 and is loaded into the RAM 202 and executed by the CPU 201.

In S1001, the CPU 201 obtains the vertical and horizontal sizes of a sheet used for print from the RAM 202. In S1002, the CPU 201 obtains, from the RAM 202, an image repeat count X for repeating the image vertically and an image repeat count Y for repeating the image horizontally (X and Y are natural numbers).

In S1003, the CPU 201 determines the position of a horizontal perforation. Specifically, the CPU 201 sets a horizontal perforation line from a position corresponding to a length obtained by dividing the vertical sheet size obtained in S1001 by X, which is the vertical image repeat count obtained in S1002, repeats this (X−1) times, and determines those positions as the positions of horizontal perforation lines.

In S1004, the CPU 201 determines the positions of vertical perforation lines. Specifically, the CPU 201 sets a vertical perforation line from a position corresponding to a length obtained by dividing the horizontal sheet size obtained in S1001 by Y, which is the horizontal image repeat count obtained in S1002, repeats this (Y−1) times, and determines those positions as the positions of vertical perforations lines. After that, the CPU 201 ends the processing of the present flowchart.

With reference to FIG. 20B, a concrete example of a perforation position determination flowchart for the image repeat function described above is described.

It is assumed here that the sheet size obtained by the CPU 201 in S801 are “8” as the vertical size and “4” as the horizontal size. It is also assumed here that in S1002, the CPU 201 obtains “8” as a vertical image repeat count and “4” as a horizontal repeat count from the RAM 202.

In S1003, the CPU 201 determines the positions of horizontal perforation lines. Specifically, the CPU 201 sets a horizontal (X-direction) perforation line from a position corresponding to a length obtained by dividing the vertical sheet size “8” by the vertical image repeat count “8” and repeats this (8−1) times (i.e., seven times). Specifically, with the coordinates of the lower left corner of the sheet being (0, 0), perforation lines are set from the positions (0, 1) to (0, 7) to the positions (4, 1) to (4, 7), respectively.

In S1004, the CPU 201 determines the positions of vertical perforation lines. Specifically, the CPU 201 sets a vertical (Y-direction) perforation line from a position corresponding to a length obtained by dividing the horizontal sheet size “4” by the horizontal image repeat count “4” and repeats this (4−1) times (i.e., three times). With the coordinates of the lower left corner of the sheet being (0, 0), perforation lines are set from the positions (1, 0), (2, 0), and (3, 0) to the positions (1, 8), (2, 8), and (3, 8), respectively.

As thus described, for the image repeat of the above settings, three vertical perforation lines and seven horizontal perforation lines are set, and the sheet is divided into 32 equal parts by the perforation lines.

As thus described above, in a case of using the image repeat function as well, the positions of perforation lines can be automatically set like in Embodiment 1. In a case where a plurality of images are allocated to a single sheet, using a suitable perforation calculation method offers expandability for the printing.

### Embodiment 3

Next, Embodiment 3 is described. Embodiment 3 has the same basic configuration as Embodiments 1 and 2 described above.

### <Screens Displayed According to Embodiment 3>

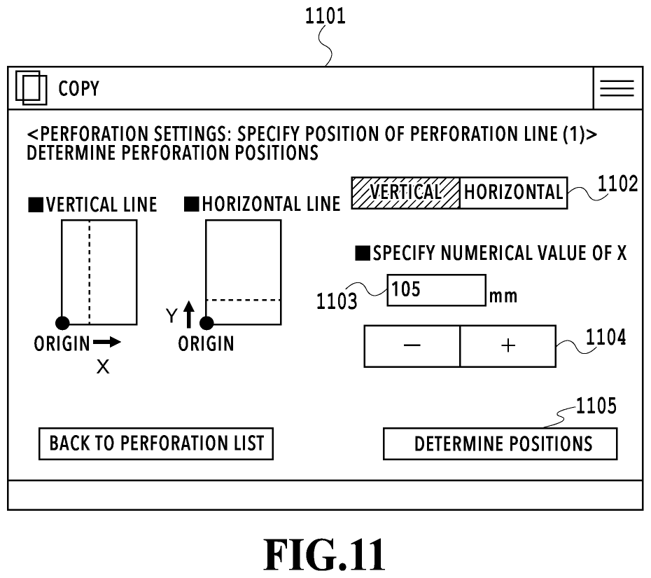

FIG. 11 is a manual perforation position setting screen 1101 showing a method of manually specifying perforation positions according to the present embodiment. The manual perforation position setting screen 1101 is a setting screen to which the list screen 401 in FIG. 4 transitions upon selection of the perforation position specification 404. The manual perforation position setting screen 1101 of the present embodiment is outputted from the window management 309 to the operation unit 212. The window management 309 is stored as the firmware 350 in the HDD 204 of the image processing apparatus 103 and is loaded into the RAM 202 and executed by the CPU 201. The manual perforation position setting screen 1101 has setting items to be set in execution of the print 311 or the copy 312, and perforation lines are drawn at particular positions on a single sheet based on the settings configured. The manual perforation position setting screen 1101 has a setting item 1102 for determining whether to draw a vertical perforation line or to draw a horizontal perforation line. In a case where vertical is selected, a perforation line is drawn vertically relative to the sheet, and in a case where horizontal is selected, a perforation line is drawn horizontally relative to the sheet. The manual perforation position setting screen 1101 has a setting item 1103 for specifying the position to draw a perforation line. A position to draw a perforation line is specified using numerical value increase and decrease buttons 1104 and is reflected in the setting item 1103. The set value is recorded in the HDD 204 upon pressing of a Determine Positions button 1105 disposed on the manual perforation position setting screen 1101.

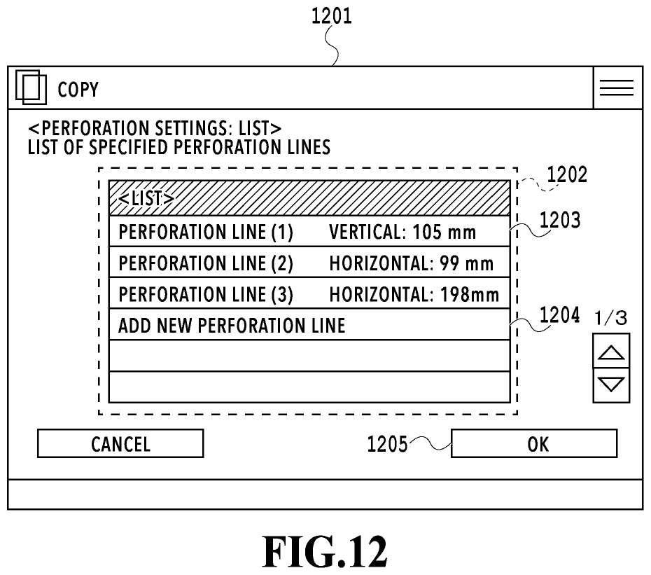

FIG. 12 is a perforation settings list screen 1201 showing manually specified perforation positions according to the present embodiment. The perforation settings list screen 1201 of the present embodiment is outputted from the window management 309 to the operation unit 212. The window management 309 is stored as the firmware 350 in the HDD 204 of the image processing apparatus 103 and is loaded into the RAM 202 and executed by the CPU 201. The perforation settings list screen 1201 has a list 1202 which lists perforation lines that are already set. A single perforation line already set is displayed on the list as a single perforation line item 1203.

Once any of the perforation line items 1203 is pressed, the perforation settings list screen 1201 transitions to the manual perforation position setting screen 1101 shown in FIG. 11 to display details of the perforation line item, including numerical values representing the position of the already-set perforation line. Specifically, in execution of the print 311 or the copy 312, upon detection of selection of the perforation position specification 404 in the function list shown in FIG. 4, the CPU 201 changes the screen to the perforation settings list screen 1201 shown in FIG. 12. Then, once any of the perforation line items 1203 is pressed on the perforation settings list screen 1201, the screen transitions to the manual perforation position setting screen 1101 shown in FIG. 11. In a case where an Add New Perforation Line button 1204 in the list 1202 is pressed, the CPU 201 displays default settings, i.e., blank settings.

Note that in a case where set values for adding perforation in between allocated pages have been set previously, the list screen 1201 may display, in the list 1202, all the perforation positions determined in S606. More specifically, for example, in a case where the checkbox 504 for automatically setting perforation positions is previously checked on the page consolidation function setting screen 501 shown in FIG. 5 for the allocated pages, the set perforation positions may be displayed in the list 1202. Also, upon pressing of any of the perforation line items 1203 displayed in the list 1202, the screen may transition to the manual perforation position setting screen 1101 as described above, and perforation position settings already automatically set can be manually changed there using numerical values. Set values are recorded in the HDD 204 upon pressing of an OK button 1205 disposed on the perforation settings list screen 1201.

### <Flowcharts According to Embodiment 3>

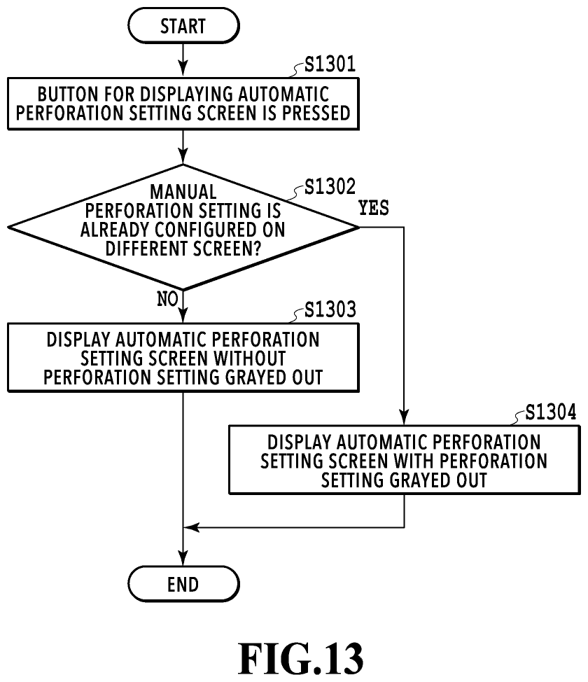

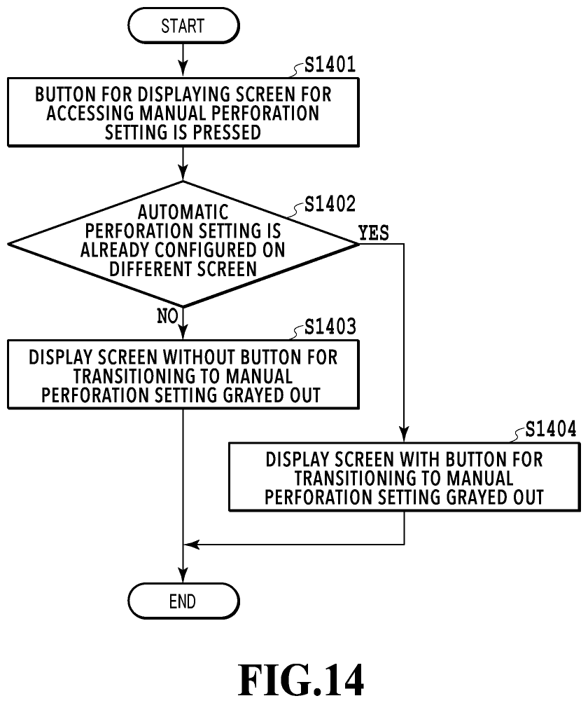

FIGS. 13 and 14 show control performed in a case where conflicting settings are set and a setting configured earlier is prioritized.

FIG. 13 is a flowchart of screen control according to the present embodiment performed in a case where a user wants to manually set perforation settings even though the perforation setting is set in addition to the setting for printing a plurality of images on a single sheet. The firmware 350 according to the processing of the present embodiment is stored in the HDD 204 of the image processing apparatus 103 and is loaded into the RAM 202 and executed by the CPU 201. Note that the present processing starts upon detection of an operation for configuring settings for execution of the print 311 or the copy 312.

In S1301, the CPU 201 detects an attempt to display a setting screen for the image consolidation function (the page consolidation 402 or the image repeat 403 in FIG. 4). This may be detecting, for example, pressing of the page consolidation 402 or the image repeat 403 in FIG. 4.

In S1302, the CPU 201 determines whether perforation settings have already been manually configured on a different screen. The different screen is, for example, the manual perforation position setting screen 1101 or the perforation settings list screen 1201.

If it is determined that perforation settings have not already been manually configured, the CPU 201 proceeds to S1303 to display the setting screen for the image consolidation function that the user tried to display in S1301, with an entry field for the perforation setting being not grayed out. The entry field is the checkbox 504 for automatically setting perforation positions in a case of the page consolidation setting screen in FIG. 5 and is the checkbox 905 for automatically setting perforation positions in a case of the image repeat function setting screen 901 in FIG. 9.

By contrast, if it is determined that perforation settings have already been manually configured, the CPU 201 proceeds to S1304 to display the setting screen for the image consolidation function that the user tried to display in S1301, with an entry field for the perforation setting being grayed out. Specifically, for example, in a case of the page consolidation setting screen in FIG. 5, the CPU 201 displays the setting screen with the checkbox 504 for automatically setting perforation positions being grayed out so as not to accept an operation for switching the perforation setting between enabled and disabled.

More specifically, in a case where the page consolidation function setting screen 501 shown in FIG. 5 is displayed with perforation settings having already been manually configured, the CPU 201 displays the setting screen with the checkbox 504 for automatically setting perforation positions being grayed out. Also, in a case where the image repeat function setting screen 901 shown in FIG. 9 is displayed with perforation settings having already been manually configured, the CPU 201 displays the image repeat function setting screen 901 with the checkbox 905 for automatically setting perforation positions being grayed out.

FIG. 14 is a flowchart of screen control according to the present embodiment performed in the following case: with perforation settings being previously manually configured, a user later tries to manually configure perforation settings in addition to the setting for printing a plurality of images on a single sheet. The firmware 350 according to the processing of the embodiment is stored in the HDD 204 of the image processing apparatus 103 and is loaded into the RAM 202 and executed by the CPU 201. Note that the present processing starts upon detection of an operation for configuring settings for execution of the print 311 or the copy 312.

In S1401, the CPU 201 detects an attempt to display a screen for manually configuring perforation settings. The screen may be, for example, the manual perforation position setting screen 1101 or the perforation settings list screen 1201.

In S1402, the CPU 201 determines whether the automatic perforation setting has already been set on a different screen in addition to the setting for printing a plurality of images on a single sheet. Specifically, for example, the CPU 201 determines whether the page consolidation function is set on the page consolidation function setting screen 501 with the checkbox 504 for automatically setting perforation positions being enabled for the allocated pages. If it is determined that the perforation setting is not set, the CPU 201 proceeds to S1403 to display the screen that the user tried to display in S1401, with a field related to the manual perforation setting not being grayed out. After that, the processing of the present flowchart ends.

By contrast, if it is determined that the perforation setting is set, the CPU 201 proceeds to S1404 to display the screen that the user tried to display in S1401, with a field related to the manual perforation setting being grayed out. This means that, for example, the perforation position specification 404 in FIG. 4 is grayed out. It also means that, for example, while the perforation position specification 404 in FIG. 4 is not grayed out but selectable, the list 1202 in FIG. 12 is grayed out. In either case, the screen is displayed in such a manner that perforation settings cannot be manually configured. After that, the processing of the present flowchart ends.

The configurations described using FIGS. 13 and 14 helps prevent confusing a user who wants to configure perforation settings and therefore helps improve convenience.

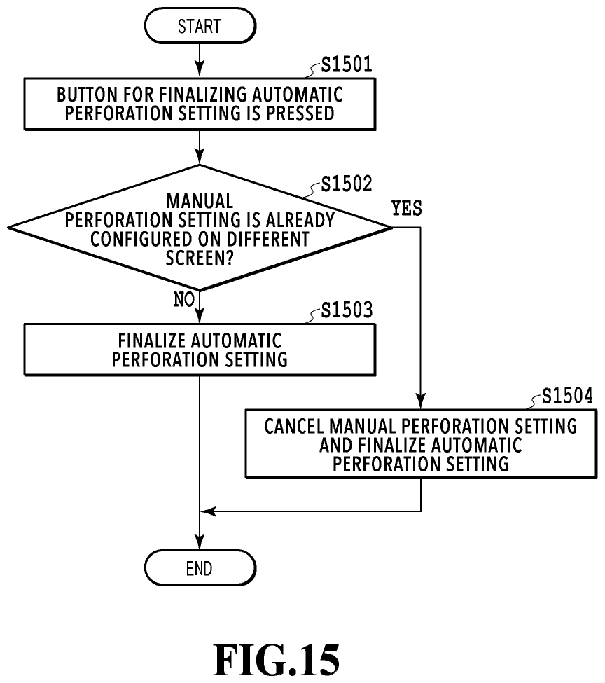

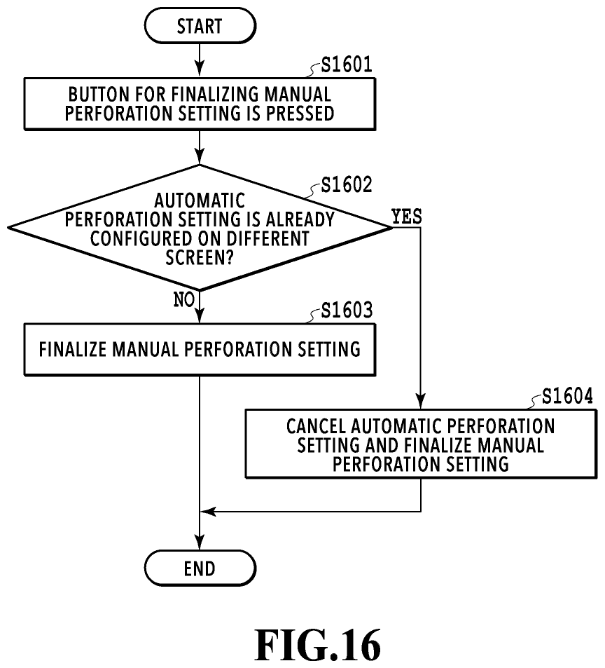

FIGS. 15 and 16 to be described next show control performed in a case where conflicting settings are configured and a setting configured later is prioritized.

FIG. 15 is a flowchart of screen control according to the present embodiment performed in a case where a user tries to finalize selection of the automatic perforation setting in addition to the setting for printing a plurality of images on a single sheet. The firmware 350 according to the processing of the embodiment is stored in the HDD 204 of the image processing apparatus 103 and is loaded into the RAM 202 and executed by the CPU 201. Note that the present processing starts upon detection of an operation for configuring settings for execution of the print 311 or the copy 312.

In S1501, the CPU 201 detects that a user tries to finalize selection of the automatic perforation setting in addition to the setting for printing a plurality of images on a single sheet. This is to detect, for example, pressing of the OK button 506 on the page consolidation function setting screen 501 with the page consolidation function being set and the checkbox 504 for automatically setting perforation positions being enabled for the allocated pages.

In S1502, the CPU 201 determines whether manual perforation settings have already been configured on a different screen. If it is determined that manual perforation settings have not been configured, the CPU 201 proceeds to S1503 to finalize selection of the automatic perforation setting that the user tried to finalize in S1501. After that, the CPU 201 ends the processing of the present flowchart.

By contrast, if it is determined that manual perforation settings have been configured, the CPU 201 proceeds to S1504 to cancel the perforation positions which have already been manually specified and configured and then finalizes selection of the automatic perforation setting that the user tried to finalize in S1501. After that, the CPU 201 ends the processing of the present flowchart.

FIG. 16 is a flowchart of screen control of the present embodiment performed in a case where a user tries to finalize selection of the manual perforation setting in addition to the setting for printing a plurality of images on a single sheet. The firmware 350 according to the processing of the present embodiment is stored in the HDD 204 of the image processing apparatus 103 and is loaded into the RAM 202 and executed by the CPU 201.

In S1601, the CPU 201 detects that a user tries to finalize manual perforation settings. This may be, for example, a user trying to finalize manual perforation settings on the manual perforation position setting screen 1101 or the perforation settings list screen 1201. In S1602, the CPU 201 determines whether the automatic perforation setting is already set on a different screen. If it is determined that the automatic perforation setting is not set, the CPU 201 proceeds to S1603 to finalize the manual perforation settings that the user tried to finalize in S1601. After that, the CPU 201 ends the processing of the present flowchart.

Meanwhile, if it determined that the automatic perforation setting is set, the CPU 201 proceeds to S1604 to cancel the automatic perforation setting already set in addition to the setting for printing a plurality of images on a single sheet and then finalizes the manual perforation settings that the user tried to finalize in S1601. After that, the CPU 201 ends the processing of the present flowchart.

The above processing saves trouble in a case where, for example, a user who manually configured perforation settings changes their mind and changes the setting to the automatic perforation setting. Specifically, the above processing eliminates an operation for going back to the setting screen for configuring manual perforation settings (the manual perforation position setting screen 1101 or the perforation settings list screen 1201). Conversely, by configuring manual perforation settings, the above processing saves the trouble of going back to the setting screen for the automatic perforation setting to cancel the automatic perforation setting already set. This improves convenience.

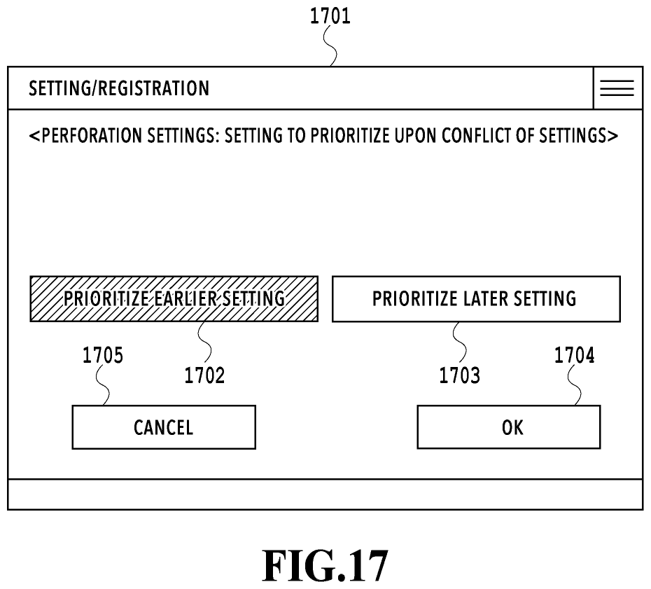

FIG. 17 is a diagram showing a setting change screen for changing, according to a user's preferences, control to be performed by the window management 309 according to the present embodiment in a case of a conflict of perforation settings.

A setting change screen 1701 has a button 1702 which is a set value for prioritizing a setting set earlier and a button 1703 which is a set value for prioritizing a setting set later. The default set value on the setting change screen 1701 at the time of shipment is the set value of the button 1702. In other words, at the time of shipment, the perforation setting set earlier is prioritized. The setting to prioritize an earlier setting or the setting to prioritize a later setting is finalized as a set value upon pressing of an OK button 1704 for finalizing the set value, with the corresponding button (the button 1702 or 1703) being pressed. In a case where a Cancel button 1705 is pressed after either the button 1702 or 1703 is pressed on the setting change screen, the original set value set before a transition to this setting change screen is held.

Based on the setting configured on this setting change screen, the CPU 201 performs control shown in FIG. 13 or 14 in a case where the button 1702 is selected or performs control shown in FIG. 15 or 16 in a case where the button 1703 is selected.

As thus described, upon conflict between the manual and automatic perforation position settings, the present embodiment lets the user change which perforation setting to prioritize according to their preferences. Because different users may have different preferences regarding processing to be performed upon conflict, the present embodiment provides processing for avoiding a conflict according to a user's preferences by allowing the user to freely select processing to be performed upon conflict.

### Embodiment 4

In the present embodiment, the image consolidation function and the perforation setting are set not on the main body of the multifunction peripheral, but on a PC using a printer driver or an application dedicated for printing, aiming to improve convenience in printing digital data on the PC, a cloud, or a server. The following describes the details.

### <Screens Displayed According to Embodiment 4>

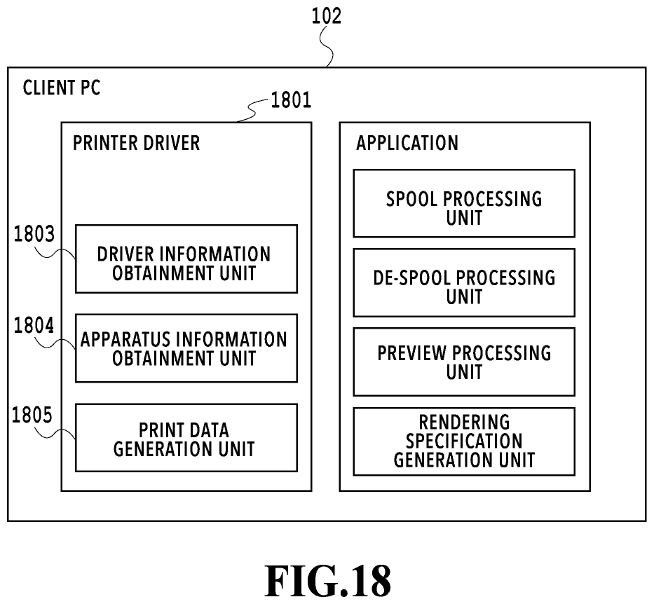

FIG. 18 is a software configuration diagram of the client PC 102 having software for a printer driver 1801 installed therein.

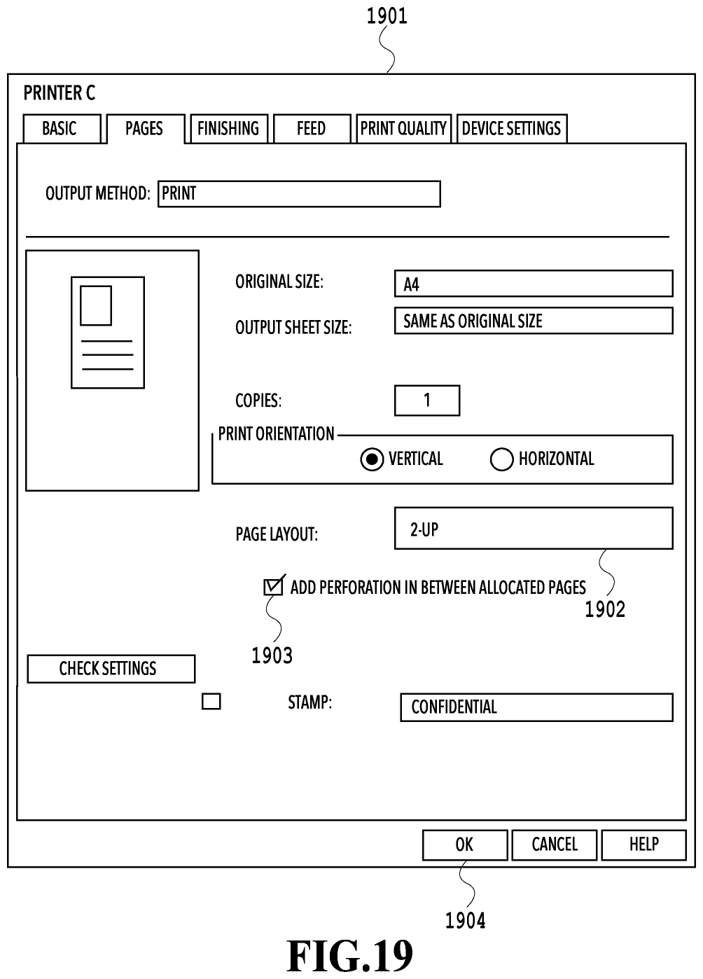

A driver information obtainment unit 1803 obtains and holds various kinds of information on the printer driver 1801. The various kinds of information include information set on a user interface of the printer driver 1801, like the one shown in FIG. 19.

An apparatus information obtainment unit 1804 obtains apparatus information on the image processing apparatus 103 via the network. The apparatus information is, for example, information on the colors of toners in the image processing apparatus 103.

A print data generation unit 1805 generates print data with which to instruct the image processing apparatus 103 to execute printing. Object generation for specifying rendering white regions necessary for printing in white is also performed by the print data generation unit 1805.

The printer driver 1801 displays a printer driver screen 1901 on the panel of the client PC 102 as requested. Although described here as being incorporated in the client PC 102, the printer driver 1801 may be configured to be incorporated in the server PC 101.

FIG. 19 is a diagram showing a printer driver screen according to the present embodiment displayed by the printer driver 1801, presenting setting items to be set for execution of print. The printer driver screen 1901 is displayed on the server PC 101 or the client PC 102.

The printer driver screen 1901 in FIG. 19 includes a similar function to that on the page consolidation function setting screen 501 in FIG. 5, and it is shown as a page layout setting 1902. The page layout setting 1902 has a set value such as 2-up or 4-up, like the page consolidation function setting screen 501 does. Also, the printer driver 1801 has a checkbox 1903 for automatically setting perforation positions, like the page consolidation function setting screen 501 in FIG. 5 does. The checkbox 1903 for automatically setting perforation positions may be indented like in FIG. 19 so as to indicate that it is an optional setting for the page layout setting 1902.

Processing performed in a case where the checkbox 1903 for automatically setting perforation positions is checked is similar to the processing described earlier using FIGS. 6 and 7. In the event where the processing is performed, set values related to the printer driver are, along with other set values, transmitted from the server PC 101 or the client PC 102 to the image processing apparatus 103 as a PDL job.

As thus described, according to the present embodiment, the image consolidation function and the perforation setting can be configured not only on the main body of the multifunction peripheral, but also on a PC using a printer driver or an application dedicated for printing. Because the image consolidation function and the perforation setting are in-demand settings in printing digital data on the PC, a cloud, or a server, the above mode may improve convenience.

### Other Embodiments

The setting screen described in Embodiment 3 using FIG. 17 is for a user to preliminary determine whether to prioritize a setting configured earlier or to prioritize a setting configured later between the automatic perforation setting and the manual perforation setting. However, the determination method is not limited to this. For example, in a case where either the automatic perforation setting or the manual perforation setting has already been configured earlier and then a user tries to configure the other setting, a notification screen may be displayed to notify that a different perforation setting has already been configured earlier. The user then may select which of the perforation settings to use on this notification screen.

Also, the automatic perforation setting and the manual perforation setting may be combined as needed. As one of such modes, for example, after the automatic perforation setting is configured, the automatically-set perforation lines can be adjusted manually, or a new perforation line can be added manually.

In the printing and processing system described above, printing or processing settings are configured on the operation unit 212 of the image processing apparatus or a setting screen displayed by a printer driver in the client PC or the like, and the image processing apparatus 103 executes printing and processing. However, the present disclosure is not limited to this. For example, printing may be executed by the image processing apparatus 103, and processing may be executed by a processing apparatus. Also, a printing and processing apparatus may execute printing and processing in response to an instruction to print and process. In other words, each process is not limited to being executed by the one described in the embodiment.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-031977, filed Mar. 4, 2024, which is hereby incorporated by reference wherein in its entirety.

What is claimed is:

1. An information processing apparatus comprising at least one memory and at least one processor which function as:
a consolidation unit that configures a setting for consolidating a plurality of sets of image data on a single sheet and
a determination unit that automatically determines a position to perforate the sheet based on the setting configured by the consolidation unit.

2. The information processing apparatus according to claim 1, wherein
the consolidation unit is configured to configure the setting by receiving a first operation by a user,
the determination unit is configured to perform processing for determining the position by receiving a second operation by the user, and
the information processing apparatus further comprises a display control unit that displays a first setting screen as a setting screen for receiving not only the first operation but also the second operation.

3. The information processing apparatus according to claim 1, wherein
the consolidation unit performs N-up or image repeat, the N-up being a function to allocate and print a plurality of originals on a single sheet, the image repeat being a function to allocate and print a particular image repeatedly on a single sheet in at least one of a vertical direction and a horizontal direction of the sheet.

4. The information processing apparatus according to claim 3, wherein
in a case where the consolidation unit performs the N-up,
the determination unit obtains a size of the sheet and a value of N (N is a multiple of 2) set for the N-up,
the determination unit determines a position of a horizontal perforation line by repeating, (N/2−1) times, setting a horizontal perforation line from a position corresponding to a length obtained by dividing a vertical size of the sheet by N/2, and
the determination unit determines a position of a vertical perforation line by setting a vertical perforation line from a position corresponding to a length obtained by dividing a horizontal size of the sheet by 2.

5. The information processing apparatus according to claim 3, wherein
in a case where the consolidation unit performs the image repeat,
the determination unit obtains a size of the sheet, a value of X (X is a natural number) indicative of a vertical image repeat count, and a value of Y (Y is a natural number) indicative of a horizontal image repeat count,
the determination unit determines a position of a horizontal perforation line by repeating, (X−1) times, setting a horizontal perforation line from a position corresponding to a length obtained by dividing a vertical size of the sheet by X, and
the determination unit determines a position of a vertical perforation line by repeating, (Y−1) times, setting a vertical perforation line from a position corresponding to a length obtained by dividing a horizontal size of the sheet by Y.

6. The information processing apparatus according to claim 1, wherein
in a case where a setting is configured to add margins to the sheet, the determination unit determines the position to perforate using vertical and horizontal sheet sizes excluding the margins.

7. The information processing apparatus according to claim 2, wherein
the display control unit displays a second setting screen for receiving an operation for manually specifying a perforation position on the sheet.

8. The information processing apparatus according to claim 7, wherein
in a case where the second operation is already received on the first setting screen, the display control unit performs control not to receive the operation for manually specifying a perforation position on the sheet on the second setting screen.

9. The information processing apparatus according to claim 8, wherein
the control not to receive the operation for specifying a perforation position on the sheet is to gray out, on the second setting screen, an entry field for configuring a perforation setting through a manual entry of a numerical value.

10. The information processing apparatus according to claim 9, wherein
in a case where the second operation is already received on the first setting screen, the display control unit performs control to cancel the second operation received earlier upon receipt of the operation for manually specifying a perforation position on the sheet on the second setting screen.

11. The information processing apparatus according to claim 9, wherein
in a case where the operation for manually specifying a perforation position on the sheet is already received on the second setting screen, the display control unit performs display control not to receive the second operation on the first setting screen.

12. The information processing apparatus according to claim 9, wherein
in a case where the operation for manually specifying a perforation position on the sheet is already received on the second setting screen,
upon receipt of the second operation on the first setting screen, the display control unit performs control to cancel the operation for manually specifying a perforation position received earlier.

13. The information processing apparatus according to claim 9, wherein
the display control unit displays a third setting screen for a user to preliminarily determine whether to prioritize an operation received earlier or to prioritize an operation received later between an operation for implementing the determination unit performed on the first setting screen and the operation for manually specifying a perforation position performed on the second setting screen.

14. The information processing apparatus according to claim 13, wherein
in a case where the operation received earlier is prioritized, the display control unit performs control so that the operation received later cannot be performed.

15. The information processing apparatus according to claim 13, wherein
in a case where the operation received later is prioritized, the display control unit performs control to cancel the operation received earlier.

16. The information processing apparatus according to claim 1, further comprising an instruction unit that instructs a printing and processing apparatus to execute printing and processing based on the consolidation unit and the determination unit.

17. A method of controlling an information processing apparatus, comprising:
configuring a setting for consolidating a plurality of sets of image data on a single sheet and
automatically determining a position to perforate the sheet based on the setting configured in the configuring.

18. A non-transitory computer readable storage medium storing a program which functions in an information processing apparatus and causes the information processing apparatus to function as:
a consolidation unit that configures a setting for consolidating a plurality of sets of image data on a single sheet and
a determination unit that automatically determines a position to perforate the sheet based on the setting configured by the consolidation unit.
